(19) United States
(12) Patent Application Publication
(10) Pub. No.: US 2020/0017090 A1
(43) Pub. Date: Jan. 16, 2020

(54) HYDRAULIC PRESSURE CONTROL UNIT FOR VEHICLE BRAKE SYSTEM

(71) Applicant: Robert Bosch GmbH, Stuttgart (DE)

(72) Inventors: Shogo Miyoshi, Kanagawa (JP); Yoshiro Akada, Kanagawa (JP)

(21) Appl. No.: 16/468,753

(22) PCT Filed: Nov. 14, 2017
(86) PCT No.: PCT/IB2017/057091

§ 371 Date: Jun. 12, 2019

(30) Foreign Application Priority Data
Dec. 12, 2016 (JP) 2016-240062

(51) Int. Cl. B60T 8/40; B60T 13/68; B60T 13/14

(52) U.S. Cl. CPC B60T 8/4068; B60T 13/147; B60T 13/686

(57) ABSTRACT

A hydraulic pressure control unit capable of reducing pulsation generated during driving of pumps and capable of suppressing enlargement of the hydraulic pressure control unit is provided.

The hydraulic pressure control unit (50) includes the plural pumps (60) used to increase a hydraulic pressure of brake fluid in each hydraulic circuit. The hydraulic pressure control unit (50) also includes a discharge channel (140) provided on discharge sides of the plural pumps (60). The discharge channel (140) includes: a merging channel (141) having a downstream end; and plural distributary channels (142) respectively communicating with the discharge sides of the pumps (60). When, of connected portions between the merging channel (141) and the distributary channels (142), the connected portion on a lowermost stream side is defined as a lowermost-stream side connected portion (143), the hydraulic pressure control unit (50) is provided with a damper unit (80) in a region on a downstream side in the merging channel (141) with the lowermost-stream side connected portion (143) being a reference, the damper unit (80) dampening the pulsation of the brake fluid discharged from each of the pumps (60).

### BACKGROUND OF THE INVENTION

The invention relates to a hydraulic pressure control unit for a vehicle brake system and, in particular, to a hydraulic pressure control unit that includes pumps used to increase a hydraulic pressure of brake fluid.

As a conventional vehicle brake system that has been available, the vehicle brake system includes a hydraulic circuit having: a primary channel that communicates between a master cylinder and a wheel cylinder; a secondary channel to which brake fluid in the primary channel is released; and a supply channel through which the brake fluid is supplied to an intermediate portion of the secondary channel.

For example, an upstream end of the secondary channel is connected to a region on the wheel cylinder side in the primary channel with an inlet valve being a reference. A downstream end of the secondary channel is connected to a region on the master cylinder side in the primary channel with the inlet valve being the reference. In addition, an upstream end of the supply channel communicates with the master cylinder. A downstream end of the supply channel is connected to a region on a downstream side in the secondary channel with an outlet valve being a reference, and is also connected to a suction side of a pump that is provided in the region. Furthermore, a first switching valve is provided in the region on the master cylinder side in the primary channel with a connected portion of the primary channel with the downstream end of the secondary channel being a reference. A second switching valve is provided in an intermediate portion of the supply channel.

For example, a hydraulic pressure control unit is configured by including the inlet valve, the outlet valve, the pump, the first switching valve, the second switching valve, a base body in which these components are embedded, and a controller that governs operations of these components. In the hydraulic pressure control unit, a hydraulic pressure in the hydraulic circuit is controlled when the operations of the inlet valve, the outlet valve, the pump, the first switching valve, and the second switching valve are controlled.

In particular, in the case where it is necessary to increase the hydraulic pressure of the brake fluid in the wheel cylinder regardless of a brake operation state in an input section (for example, a brake pedal or the like) of the brake system, the pump is driven in a state where the inlet valve is opened, the outlet valve is closed, the first switching valve is closed, and the second switching valve is opened.

When the pump is driven, pulsation that is generated in the brake fluid is possibly transmitted from the brake system to an engine room in the vehicle and possibly causes generation of noise. This noise occasionally becomes so loud that a user (driver) receives a sense of discomfort. For this reason, the conventional hydraulic pressure control unit for the brake system that is designed to reduce the pulsation generated during driving of the pump has been proposed. For example, a hydraulic pressure control unit for a brake system disclosed in JP-A-2013-249055 includes a pump in each hydraulic circuit and also includes a damper unit on a discharge side of the pump. The damper unit dampens pulsation of brake fluid that is discharged from the pump. For example, in a hydraulic pressure control unit for a brake system disclosed in JP-A-2014-205483, three pumps are connected in parallel in each hydraulic circuit. Because the three pumps are connected in parallel, a discharge amount of brake fluid from each of the pumps can be reduced, and discharge timing of the brake fluid from the pumps can differ. In this way, the pulsation that is generated during driving of the pumps can be reduced.

In the recent brake system, a booster is occasionally downsized or not provided for a purpose of improved installability of the brake system in the vehicle. In such a brake system, a driving frequency of the pump is increased because the hydraulic pressure of the brake fluid in the wheel cylinder is frequently shortened. In other words, the noise, which is resulted from the pulsation generated during driving of the pump, is more likely to be generated in such a brake system. Thus, a demand for the further reduction of the pulsation, which is generated during driving of the pump, has been intensified in recent years.

As a configuration that realizes the further reduction of the pulsation generated during driving of the pump, it is considered to combine a configuration of the hydraulic pressure control unit for the brake system disclosed in JP-A-2013-249055 and a configuration of the hydraulic pressure control unit for the brake system disclosed in JP-A-2014-205483. That is, it is considered to adopt a configuration that the three pumps are connected in parallel in each of the hydraulic circuits and the damper unit for dampening the pulsation is provided on the discharge side of each of the three pumps. In such a configuration, the three damper units per hydraulic circuit are added to the configuration of the hydraulic pressure control unit for the brake system disclosed in JP-A-2014-205483. This leads to enlargement of the hydraulic pressure control unit and thus opposes the current request for the improved installability of the brake system in the vehicle.

### SUMMARY OF THE INVENTION

The invention has been made in view of the above-described problem and therefore has a purpose of providing a hydraulic pressure control unit capable of reducing pulsation that is generated during driving of a pump in comparison with a conventional hydraulic pressure control unit and also capable of inhibiting enlargement of the hydraulic pressure control unit.

A hydraulic pressure control unit according to the invention is a hydraulic pressure control unit for a vehicle brake system. The brake system includes a hydraulic circuit having: a primary channel that communicates between a master cylinder and a wheel cylinder; a secondary channel to which brake fluid in the primary channel is released; and a supply channel through which the brake fluid is supplied to a first intermediate portion as an intermediate portion of the secondary channel. A first downstream end as a downstream end of the secondary channel is connected to a second intermediate portion as an intermediate portion of the primary channel. A first upstream end as an upstream end of the supply channel communicates with the master cylinder. The hydraulic pressure control unit includes: an inlet valve that is provided in a region on the wheel cylinder side in the primary channel with the second intermediate portion being a reference; an outlet valve that is provided in a region between a second upstream end and the first intermediate portion in the secondary channel, the second upstream end being an upstream end of the secondary channel; a first switching valve that is provided on the master cylinder side in the primary channel with the second intermediate portion being a reference; a second switching valve that is provided in the supply channel; plural pumps that are provided in a region between the first intermediate portion and the first downstream end in the secondary channel, suction sides thereof communicating with the first intermediate portion, and discharge sides thereof communicating with the first downstream end; and a discharge channel that constitutes a part of the secondary channel and constitutes a channel between the discharge side of each of the plural pumps and the first downstream end. The discharge channel includes: a merging channel that has the first downstream end; and distributary channels that are respectively provided for the pumps and respectively communicate with the discharge sides of the pumps. Each of the distributary channels is connected to one of the other distributary channels or the merging channel. When, of connected portions between the merging channel and the distributary channels, the connected portion that is located closest to the first downstream end is defined as a lowermost-stream side connected portion, the hydraulic pressure control unit includes a damper unit in a region on the first downstream end side in the merging channel with the lowermost-stream side connected portion being a reference, the damper unit dampening pulsation of the brake fluid that is discharged from the plural pumps.

The hydraulic pressure control unit according to the invention includes the plural pumps at the above-described positions in the secondary channel. That is, the hydraulic pressure control unit according to the invention includes the plural pumps, each of which increases a hydraulic pressure of the brake fluid, in the one hydraulic circuit. Accordingly, the hydraulic pressure control unit according to the invention can reduce a discharge amount of the brake fluid from each of the pumps, and discharge timing of the brake fluid from each of the pumps can differ. Thus, the pulsation that is generated during driving of the pumps can be reduced. Furthermore, the hydraulic pressure control unit according to the invention includes the damper unit that dampens the pulsation of the brake fluid discharged from the pumps. Thus, the hydraulic pressure control unit according to the invention can further reduce the pulsation that is generated during driving of the pumps.

Here, the hydraulic pressure control unit according to the invention includes the discharge channel that constitutes the part of the secondary channel and that constitutes the channel between the discharge side of each of the plural pumps and the first downstream end as the downstream end of the secondary channel. The discharge channel includes: the merging channel that has the first downstream end; and the distributary channels that are respectively provided for the pumps and respectively communicate with the discharge sides of the pumps. Each of the distributary channels is connected to one of the other distributary channels or the merging channel. When, of the connected portions between the merging channel and the distributary channels, the connected portion that is located closest to the first downstream end is defined as the lowermost-stream side connected portion, the hydraulic pressure control unit according to the invention is provided with the above-described damper unit in the region on the first downstream end side in the merging channel with the lowermost-stream side connected portion being the reference, and the damper unit dampens the pulsation of the brake fluid that is discharged from the pumps. Thus, in the hydraulic pressure control unit according to the invention, the single damper unit can dampen the pulsation of the brake fluid that is discharged from the plural pumps. Therefore, the hydraulic pressure control unit according to the invention can also suppress enlargement of the hydraulic pressure control unit.

### BRIEF DESCRIPTION OF THE DRAWINGS

FIG. 1 is a diagram of a system configuration example of a brake system according to an embodiment of the invention.

FIG. 2 is a diagram of another system configuration example of the brake system according to the embodiment of the invention.

FIG. 3 is a partial cross-sectional view of an example of a state where pumps and damper units are installed in a base body of a hydraulic pressure control unit for the brake system according to the embodiment of the invention.

FIG. 4 is a partial cross-sectional view of another example of the state where the pumps and the damper units are installed in the base body of the hydraulic pressure control unit for the brake system according to the embodiment of the invention.

### DETAILED DESCRIPTION

A description will hereinafter be made on a hydraulic pressure control unit according to the invention by using the drawings.

Note that the following description will be made on a case where a brake system that includes the hydraulic pressure control unit according to the invention is mounted on a four-wheeled vehicle; however, the brake system that includes the hydraulic pressure control unit according to the invention may be mounted on vehicles other than the four-wheeled vehicle (a motorcycle, a truck, a bus, and the like). A configuration, an operation, and the like, which will be described below, constitute merely one example, and the brake system that includes the hydraulic pressure control unit according to the invention is not limited to a case with such a configuration, such an operation, and the like. In the drawings, the same or similar members or portions will be denoted by the same reference sign or will not be denoted by a reference sign. In addition, a detailed structure will appropriately be depicted in a simplified manner or will not be depicted.

### Embodiment

A description will hereinafter be made on a brake system 1 according to this embodiment.

### <Configuration and Operation of Brake System 1>

A description will be made on a configuration and an operation of the brake system 1 according to this embodiment.

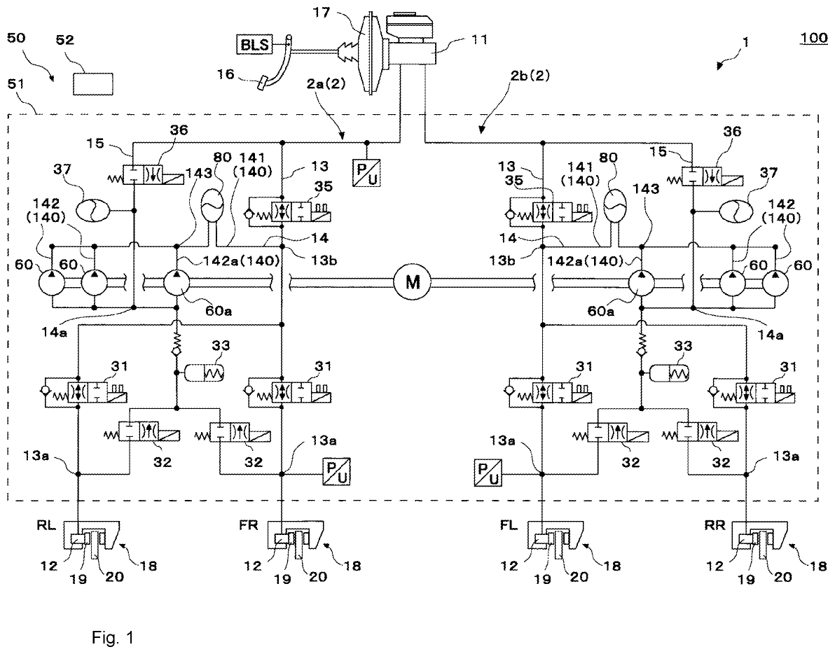

FIG. 1 is a diagram of a system configuration example of the brake system according to the embodiment of the invention.

As depicted in FIG. 1, the brake system 1 is mounted on a vehicle 100 and includes hydraulic circuits 2. Each of the hydraulic circuits 2 has: a primary channel 13 that communicates between a master cylinder 11 and wheel cylinders 12; a secondary channel 14, to which brake fluid in the primary channel 13 is released; and a supply channel 15, through which the brake fluid is supplied to the secondary channel 14. Each of the hydraulic circuits 2 is filled with the brake fluid. Note that the brake system 1 according to this embodiment includes two hydraulic circuits 2a, 2b as the hydraulic circuits 2. The hydraulic circuit 2a is a hydraulic circuit that communicates between the master cylinder 11 and the wheel cylinder 12 of each of wheels RL, FR through the primary channel 13. The hydraulic circuit 2b is a hydraulic circuit that communicates between the master cylinder 11 and the wheel cylinder 12 of each of wheels FL, RR through the primary channel 13. These hydraulic circuits 2a, 2b have the same configuration except that the wheel cylinders 12 communicating therewith differ.

A piston (not depicted) is installed in the master cylinder 11, and the piston reciprocates in an interlocking manner with a brake pedal 16 as an example of an input section of the brake system 1. A booster 17 is interposed between the brake pedal 16 and the piston in the master cylinder 11, and a depression force by a user is boosted and transmitted to the piston. The wheel cylinder 12 is provided in a brake caliper 18. When a hydraulic pressure of the brake fluid in the wheel cylinder 12 is increased, a brake pad 19 of the brake caliper 18 is pressed against a rotor 20, and the wheel is thereby braked.

An upstream end of the secondary channel 14 is connected to an intermediate portion 13a of the primary channel 13, and a downstream end of the secondary channel 14 is connected to an intermediate portion 13b of the primary channel 13. An upstream end of the supply channel 15 communicates with the master cylinder 11, and a downstream end of the supply channel 15 is connected to an intermediate portion 14a of the secondary channel 14.

The upstream end of the secondary channel 14 corresponds to the second upstream end of the invention. The downstream end of the secondary channel 14 corresponds to the first downstream end of the invention. The intermediate portion 13b of the primary channel 13 corresponds to the second intermediate portion of the invention. The upstream end of the supply channel 15 corresponds to the first upstream end of the invention. The intermediate portion 14a of the secondary channel 14 corresponds to the first intermediate portion of the invention.

An inlet valve (EV) 31 is provided in a region between the intermediate portion 13b and the intermediate portion 13a in the primary channel 13 (a region on the wheel cylinder 12 side with the intermediate portion 13b being a reference). An outlet valve (AV) 32 is provided in a region between the upstream end and the intermediate portion 14a in the secondary channel 14. An accumulator 33 is provided in a region between the outlet valve 32 and the intermediate portion 14a in the secondary channel 14. The inlet valve 31 is an electromagnetic valve that is opened in an unenergized state and closed in an energized state, for example. The outlet valve 32 is an electromagnetic valve that is closed in the unenergized state and opened in the energized state, for example.

Plural pumps 60 are provided in a region between the intermediate portion 14a and the downstream end in the secondary channel 14. FIG. 1 depicts an example in which the three pumps 60 are provided in each of the hydraulic circuits 2a, 2b. Suction sides of these plural pumps 60 communicate in parallel with the intermediate portion 14a, for example. Discharge sides of these plural pumps 60 communicate with the downstream end of the secondary channel 14. In detail, the brake system 1 includes a discharge channel 140 as a part of the secondary channel 14 as a configuration of a hydraulic pressure control unit 50. The discharge channel 140 constitutes a channel between the discharge sides of the plural pumps 60 and the downstream end of the secondary channel 14. This discharge channel 140 includes: a merging channel 141 that has the downstream end of the secondary channel 14; and distributary channels 142 that are respectively provided for the pumps 60 and respectively communicate with the discharge sides of the pumps 60. Each of the distributary channels 142 is connected to the merging channel 141.

Of connected portions between the merging channel 141 and the distributary channels 142, the connected portion that is located closest to the downstream end of the secondary channel 14 is defined as a lowermost-stream side connected portion 143. With such a definition, the brake system 1, that is, the hydraulic pressure control unit 50 includes a damper unit 80 in a region on the downstream end side of the secondary channel 14 in the merging channel 141 with the lowermost-stream side connected portion 143 being a reference, and the damper unit 80 dampens pulsation of the brake fluid that is discharged from the plural pumps 60. Note that, in the following description, the distributary channel 142 that is connected to the merging channel 141 in the lowermost-stream side connected portion 143 will be referred to as a first distributary channel 142a when it is desired to distinguish such a distributary channel 142 from the other distributary channels 142. In addition, of the plural pumps 60, the pump 60 whose discharge side communicates with the first distributary channel 142a will be referred to as a first pump 60a when it is desired to distinguish such a pump 60 from the other pumps 60.

A first switching valve (USV) 35 is provided in a region on the master cylinder 11 side in the primary channel 13 with the intermediate portion 13b being the reference. The supply channel 15 is provided with a second switching valve (HSV) 36 and a damper unit 37. The damper unit 37 is provided in a region between the second switching valve 36 and the downstream end of the supply channel 15. The first switching valve 35 is an electromagnetic valve that is opened in the unenergized state and closed in the energized state, for example. The second switching valve 36 is an electromagnetic valve that is closed in the unenergized state and opened in the energized state.

The inlet valves 31, the outlet valves 32, the accumulators 33, the pumps 60, the first switching valves 35, the second switching valves 36, the damper units 37, and the damper units 80 are provided in a base body 51 that is formed with channels constituting the primary channels 13, the secondary channels 14, and the supply channels 15 therein. The members (the inlet valves 31, the outlet valves 32, the accumulators 33, the pumps 60, the first switching valves 35, the second switching valves 36, the damper units 37, and the damper units 80) may collectively be provided in the single base body 51 or may be divided into the plural base bodies 51.

The hydraulic pressure control unit 50 is configured by at least including the base body 51, the members provided in the base body 51, and a controller (ECU) 52. In the hydraulic pressure control unit 50, when the controller 52 controls operations of the inlet valve 31, the outlet valve 32, the pumps 60, the first switching valve 35, and the second switching valve 36, the hydraulic pressure of the brake fluid in each of the wheel cylinders 12 is controlled. That is, the controller 52 governs the operations of the inlet valves 31, the outlet valves 32, the pumps 60, the first switching valves 35, and the second switching valves 36.

The controller 52 may be provided as one unit or may be divided into plural units. In addition, the controller 52 may be attached to the base body 51 or may be attached to another member. Furthermore, the controller 52 may partially or entirely be constructed of a microcomputer, a microprocessor unit, or the like, may be constructed of a member in which firmware and the like can be updated, or may be a program module or the like that is executed by a command from a CPU or the like, for example.

The controller 52 performs the following hydraulic pressure control operation in addition to well-known hydraulic pressure control operations (an ABS control operation, an ESP control operation, and the like).

In the case where shortage or possible shortage of the hydraulic pressure in the hydraulic circuit 2 is detected from a detection signal of a position sensor for the brake pedal 16 and a detection signal of a hydraulic pressure sensor for the hydraulic circuit 2 when the brake pedal 16 of the vehicle 100 is operated in a state where the inlet valve 31 is opened, the outlet valve 32 is closed, the first switching valve 35 is opened, and the second switching valve 36 is closed, the controller 52 initiates an active pressure build-up control operation.

In the active pressure build-up control operation, the controller 52 maintains the opened state of the inlet valve 31 and thereby allows a flow of the brake fluid from the intermediate portion 13b of the primary channel 13 to the wheel cylinder 12. In addition, the controller 52 maintains the closed state of the outlet valve 32 and thereby restricts a flow of the brake fluid from the wheel cylinder 12 to the accumulator 33. Furthermore, the controller 52 closes the first switching valve 35 and thereby restricts a flow of the brake fluid in the channel from the master cylinder 11 to the intermediate portion 13b of the primary channel 13 without interposing the pumps 60. Moreover, the controller 52 opens the second switching valve 36 and thereby allows a flow of the brake fluid in the channel from the master cylinder 11 to the intermediate portion 13b of the primary channel 13 via the pumps 60. Then, the controller 52 drives the pumps 60 so as to increase (build up) the hydraulic pressure of the brake fluid in the wheel cylinder 12.

When it is detected that the shortage of the hydraulic pressure in the hydraulic circuit 2 is resolved or avoided, the controller 52 opens the first switching valve 35, closes the second switching valve 36, and stops driving the pumps 60, so as to terminate the active pressure build-up control operation.

At this time, when the pumps 60 are driven, the pulsation, which is generated in the brake fluid, is occasionally transmitted to each of the wheel cylinders 12 through the secondary channel 14 and the primary channel 13. Then, such pulsation is transmitted to an engine room that accommodates the hydraulic pressure control unit 50 for the brake system 1, and occasionally generates noise. This noise occasionally becomes so loud that the user (driver) feels uncomfortable. Thus, it is important to reduce the pulsation, which is generated during driving of the pumps 60.

To handle the above problem, the brake system 1 according to this embodiment, that is, the hydraulic pressure control unit 50 increases the hydraulic pressure of the brake fluid by using the plural pumps 60. In this way, a discharge amount of the brake fluid from each of the pumps 60 can be reduced. In addition, discharge timing of the brake fluid from each of the pumps 60 can differ. Thus, the brake system 1 according to this embodiment, that is, the hydraulic pressure control unit 50 increases the hydraulic pressure of the brake fluid by using the plural pumps 60 and can thereby reduce the pulsation, which is generated during driving of the pumps 60.

In the brake system 1 according to this embodiment, that is, the hydraulic pressure control unit 50, the entire brake fluid that is discharged from the pumps 60 flows through the distributary channels 142, which respectively communicate with the discharge sides of the pumps 60, merges in the lowermost-stream side connected portion 143, and flows into the damper unit 80. Then, the brake fluid that has flowed into the damper unit 80 flows from the damper unit 80 to the downstream side after the damper unit 80 dampens the pulsation of the brake fluid. Thus, the brake system 1 according to this embodiment, that is, the hydraulic pressure control unit 50 can further reduce the pulsation, which is generated during driving of the pumps 60. In addition, the brake system 1 according to this embodiment, that is, the hydraulic pressure control unit 50 only needs to include the single damper unit 80 in each of the hydraulic circuits. Thus, enlargement of the hydraulic pressure control unit 50 can be suppressed.

Note that, in the above-described active pressure build-up operation, the pumps 60 are driven in a state where the user operates (depresses) the brake pedal 16 and each of the second switching valve 36 is opened. Accordingly, the pulsation, which is generated in the brake fluid, is transmitted to the brake pedal 16 via the supply channel 15 and the master cylinder 11 and gives the sense of discomfort to the user. Thus, as depicted in FIG. 1, the brake system 1 according to this embodiment, that is, the hydraulic pressure control unit 50 preferably includes the damper units 37. It is because each of the damper units 37 can dampen the pulsation of the brake fluid that is transmitted from the pumps 60 to the brake pedal 16.

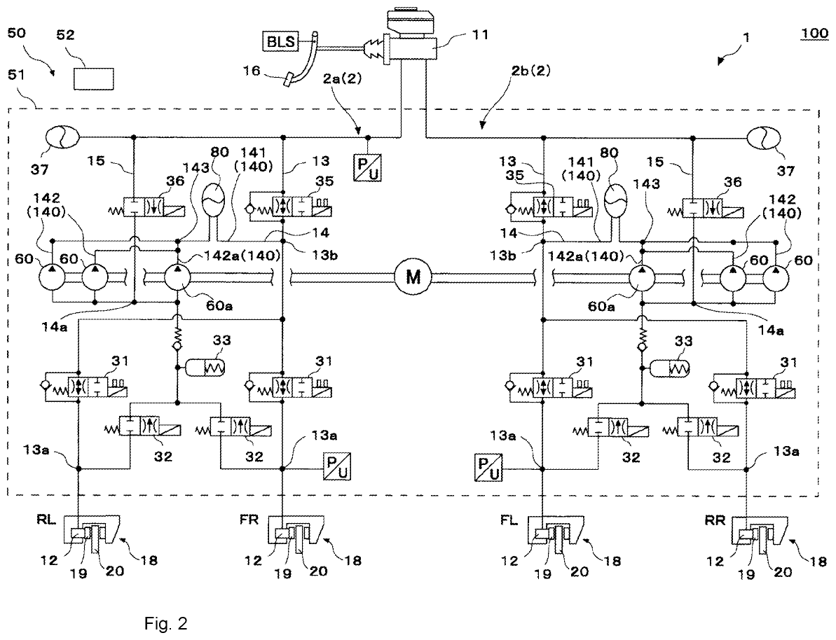

FIG. 2 is a view of another system configuration example of the brake system according to the embodiment of the invention.

For example, as depicted in FIG. 2, each of the distributary channels 142 may not be connected to the merging channel 141 but may be connected to one of the other distributary channels 142. That is, the entire brake fluid, which is discharged from all of the pumps 60, only needs to merge when flowing through the lowermost-stream side connected portion 143.

In addition, the brake system 1 may be the brake system 1 that does not include the booster 17 as depicted in FIG. 2. In the case of such a brake system 1 that does not include the booster 17, the depression force of the brake pedal 16 by the user is not boosted by the booster 17. Accordingly, the hydraulic pressure of the brake fluid in each of the wheel cylinders 12 more frequently runs short, which leads to increased driving frequencies of the pumps 60. In other words, in the brake system 1 that does not include the booster 17, the noise resulted from the pulsation, which is generated during driving of the pumps 60, is more likely to be generated. Thus, it is further effective to install the above-described damper units 80 in the brake system 1 that does not include the booster 17.

In addition, in the case of the brake system 1 that does not include the booster 17, the depression force of the brake pedal 16 by the user is not boosted by the booster 17 and is directly transmitted to the piston in the master cylinder 11. Thus, when the user attempts to depress the brake pedal 16, the hydraulic pressure of the brake fluid in each of the hydraulic circuits 2 acts as a reaction force on the brake pedal 16 via the piston in the master cylinder 11.

Due to this reaction force of the brake fluid in each of the hydraulic circuits 2 that is transmitted to the brake pedal 16, the user is refrained from depressing the brake pedal 16 as much as he/she does with the brake system 1 that includes the booster 17 in a period from timing at which the user starts depressing the brake pedal 16 to timing at which the active pressure build-up control operation is initiated. That is, in the case of the brake system 1 that does not include the booster 17, the depression amount of the brake pedal 16 is smaller than that in the brake system 1 that includes the booster 17 in the period from the timing at which the user starts depressing the brake pedal 16 to the timing at which the active pressure build-up control operation is initiated.

Accordingly, in the case where the damper units 37 are provided in the brake system 1 that does not include the booster 17, each of the damper units 37 is preferably provided in a region between the upstream end and the second switching valve 36 in the supply channel 15. Due to provision of each of the damper units 37 at such a position, the brake fluid can flow into the damper unit 37 after the user depresses the brake pedal 16, and the reaction force of the brake fluid in the hydraulic circuit 2, which is transmitted to the brake pedal 16, is reduced. Thus, when the user depresses the brake pedal, it is possible to obtain the same amount of the depression force of the brake pedal 16 as that in the brake system 1 including the booster 17. Therefore, when using the brake system 1 that does not include the booster 17, the user can receive the same sense of use as that received when using the brake system 1 that includes the booster 17.

### <Installation Configuration of Pumps 60 and Damper Units 80 in Base Body 51>

A description will be made on an example of a configuration at a time when the pumps 60 and the damper units 80 are installed in the base body 51 of the hydraulic pressure control unit 50 for the brake system 1 according to this embodiment.

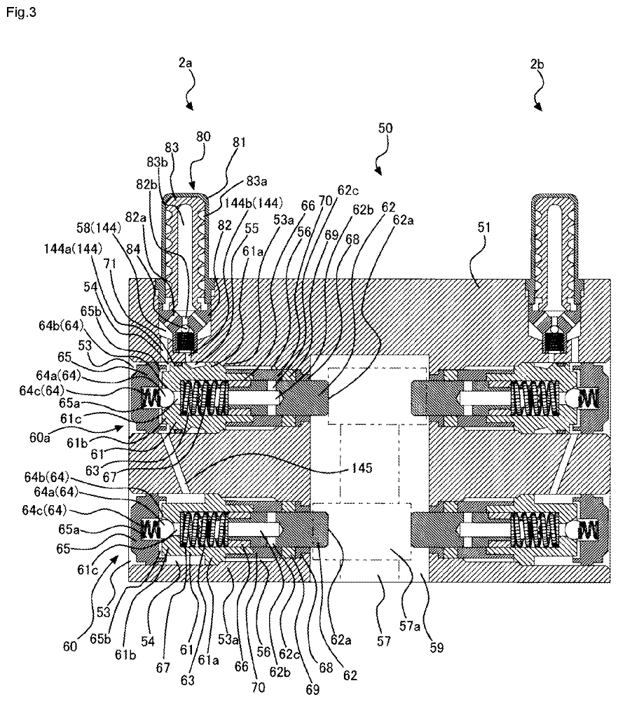

FIG. 3 is a partial cross-sectional view of an example of a state where the pumps and the damper units are installed in the base body of the hydraulic pressure control unit for the brake system according to the embodiment of the invention. Note that FIG. 3 depicts an example in which the two pumps 60 are provided in each of the hydraulic circuits 2a, 2b. That is, FIG. 3 depicts the example of providing the two pumps 60 in each of the hydraulic circuits. FIG. 3 also depicts a state where a drive shaft 57 that drives a piston 62 in each of the pumps 60 is removed. Thus, FIG. 3 depicts the drive shaft 57 and eccentric portions 57a provided on the drive shaft 57 by phantom lines (two-dot chain lines).

As depicted in FIG. 3, the base body 51 is formed with an accommodation chamber 59 in which the drive shaft 57 that drives the piston 62 in each of the pumps 60 is provided. The accommodation chamber 59 is a bottomed hole formed on an outer wall of the base body 51. The base body 51 is also formed with plural accommodation chambers 53 that respectively accommodate the pumps 60. Each of these accommodation chambers 53 is a stepped through-hole that penetrates the base body 51 from the outer wall thereof to the accommodation chamber 59.

Each of the pumps 60, which are respectively accommodated in the accommodation chambers 53, includes a cylinder 61, the piston 62, and the like. The cylinder 61 is formed in a bottomed cylindrical shape having a bottom portion 61b. The cylinder 61 accommodates one end side of the piston 62. A space that is surrounded by an inner peripheral surface of the cylinder 61 and the one end of the piston 62 constitutes a pump chamber 63. This piston 62 freely reciprocates in an axial direction of the cylinder 61. An end 62a that is the other end of the piston 62 protrudes into the accommodation chamber 59. An annular seal member 66 is attached to a portion of the piston 62 that is accommodated in the cylinder 61. This seal member 66 prevents leakage of the brake fluid between an outer peripheral surface of the piston 62 and the inner peripheral surface of the cylinder 61.

In the cylinder 61, a spring 67 is accommodated between the bottom portion 61b and the piston 62, that is, in the pump chamber 63. This spring 67 constantly urges the piston 62 to the accommodation chamber 59 side. In this way, the end 62a of the piston 62 abuts the eccentric portion 57a, which is formed on the drive shaft 57 in the accommodation chamber 59. A center position of each of the eccentric portions 57a is eccentric with respect to a rotation center of the drive shaft 57. Thus, when the drive shaft 57 is rotated by a drive source, which is not depicted, each of the eccentric portion 57a is eccentrically rotated with respect to the rotation center of the drive shaft 57. That is, due to eccentric rotary movement of each of the eccentric portions 57a, the piston 62 whose end 62a abuts the eccentric portion 57a reciprocates in the axial direction of the cylinder 61.

A portion of the piston 62 that protrudes from the cylinder 61 is slidably guided by a guide member 68 that is provided on an inner peripheral surface of the accommodation chamber 53. In the accommodation chamber 53, an annular seal member 69 is disposed next to the guide member 68 and is attached thereto. This seal member 69 prevents outflow of the brake fluid from the outer peripheral surface of the piston 62 in a liquid-tight manner.

The piston 62 is axially formed with a bottomed hole 62b that is opened to the pump chamber 63 side of the cylinder 61. The piston 62 is also formed with an inlet 62c that is a through-hole communicating between the outer peripheral surface of the piston 62 and the bottomed hole 62b. The piston 62 is provided with an inlet valve that is not depicted and closes an opening of the bottomed hole 62b in a freely openable/closable manner. This inlet valve includes: a ball valve that closes the opening of the bottomed hole 62b; and a spring that urges the ball valve from the cylinder 61 side. A cylindrical filter 70 is attached to an end of the cylinder 61 on the piston 62 side in a manner to cover an opening of the inlet 62c of the piston 62.

In the bottom portion 61b of the cylinder 61, a through-hole 61c is formed to communicate between the pump chamber 63 and outside of the cylinder 61. A discharge valve 64 is provided on an opening side of this through-hole 61c that is opposite side from the pump chamber 63. The discharge valve 64 includes: a ball valve 64a; a valve seat 64b that is formed at a peripheral edge of an opening end of the through-hole 61c and allows the ball valve 64a to be seated thereon; and a spring 64c that urges the ball valve 64a in a direction to be seated on the valve seat 64b. This discharge valve 64 is disposed between the cylinder 61 and a cover 65.

In detail, the cover 65 is press-fitted to the bottom portion 61b of the cylinder 61, for example. This cover 65 is formed with a bottomed hole 65a that has an opening at a position opposing the through-hole 61c of the bottom portion 61b. The bottomed hole 65a accommodates the spring 64c of the discharge valve 64. An inner diameter of the bottomed hole 65a is larger than an outer diameter of the ball valve 64a. Thus, when the ball valve 64a separates from the valve seat 64b, the ball valve 64a moves into the bottomed hole 65a. More specifically, when the hydraulic pressure of the brake fluid in the pump chamber 63 of the cylinder 61 is increased and a force of the brake fluid that presses the ball valve 64a becomes larger than an urging force of the spring 64c, the ball valve 64a separates from the valve seat 64b, and the pump chamber 63 communicates with the bottomed hole 65a of the cover 65 via the through-hole 61c. Then, the brake fluid in the pump chamber 63 flows into the bottomed hole 65a. The cover 65 is formed with a groove as an outlet 65b that communicates between outside of the cover 65 and the bottomed hole 65a. The brake fluid that has flowed into the bottomed hole 65a of the cover 65 is discharged from the outlet 65b to the outside of the cover 65, that is, the outside of the pump 60.

As described above, the thus-configured pump 60 is accommodated in the accommodation chamber 53 that is formed in the base body 51. More specifically, a portion around an opening of the accommodation chamber 53 is caulked in a state where an annular protrusion 61a that is formed in an outer peripheral portion of the cylinder 61 abuts a stepped portion 53a of the accommodation chamber 53. In this way, the pump 60 is fixed to the inside of the accommodation chamber 53 of the base body 51.

When the pump 60 is accommodated in the accommodation chamber 53 as described above, a discharge chamber 54 is formed between an outer peripheral surface of the pump 60 and the inner peripheral surface of the accommodation chamber 53, and the discharge chamber 54 is a space that communicates with the outlet 65b of the pump 60. That is, the discharge chamber 54 is a space that is formed annularly on the outer peripheral side of the pump 60 in the manner to communicate with the outlet 65b of the pump 60. As will be described below, the discharge chamber 54 constitutes a part of the distributary channel 142. Due to provision of the discharge chamber 54, when the pump 60 is accommodated in the accommodation chamber 53, positioning of the pump 60 is unnecessary for the connection between the outlet 65b of the pump 60 and the distributary channel 142. Thus, due to the provision of the discharge chamber 54, the hydraulic pressure control unit 50 can easily be assembled. In addition, due to the provision of the discharge chamber 54, when the accommodation chamber 53 is processed in the base body 51, the distributary channel 142 is also partially processed. Thus, it is possible to cut processing cost of the base body 51, that is, manufacturing cost of the hydraulic pressure control unit 50. Furthermore, due to the provision of the discharge chamber 54, the space on the outer peripheral side of the pump 60 can effectively be used as the distributary channel 142. Thus, the base body 51, that is, the hydraulic pressure control unit 50 can be downsized.

In the case of the pumps 60 other than the first pump 60a, the space that serves as this discharge chamber 54 is formed between the annular protrusion 61a of the cylinder 61 and the cover 65. Meanwhile, in the first pump 60a, a space between the annular protrusion 61a of the cylinder 61 and the cover 65 is partitioned into two spaces by a partitioning portion 71. Then, the space on the cover 65 side from the partitioning portion 71 serves as the discharge chamber 54. Meanwhile, the space on the protrusion 61a side from the partitioning portion 71 serves as an annular channel 55. Note that, as depicted in FIG. 3, in this embodiment, the partitioning portion 71 is configured by including: a protrusion that protrudes annularly on an outer peripheral surface of the cylinder 61; and an O-ring that is provided in the protrusion. However, any configuration can be adopted for the partitioning portion 71 as long as the space between the annular protrusion 61a of the cylinder 61 and the cover 65 can be partitioned into the two spaces. For example, the partitioning portion 71 may be configured by only including the protrusion that protrudes annularly on the outer peripheral surface of the cylinder 61. Alternatively, for example, the partitioning portion 71 may be configured by only including the O-ring that is provided on the outer peripheral surface of the cylinder 61.

Here, the annular channel 55, which is the space on the protrusion 61a side from the partitioning portion 71, corresponds to the first space of the invention. The discharge chamber 54, which is the space on the cover 65 side from the partitioning portion 71, corresponds to the second space of the invention.

The base body 51 is formed with a second connection channel 145 that is a channel communicating between the discharge chambers 54. As depicted in FIG. 3, in the case where the two pumps 60 are provided in each of the hydraulic circuits, the second connection channel 145 connects (communicates between) the discharge chamber 54 that is formed on an outer peripheral surface side of the pump 60 other than the first pump 60a and the discharge chamber 54 that is formed on an outer peripheral surface side of the first pump 60a. Accordingly, the brake fluid discharged from the outlet 65b of the pump 60 other than the first pump 60a flows through the discharge chamber 54, which is formed on the outer peripheral surface side of the pump 60, and the second connection channel 145, flows into the discharge chamber 54 formed on the outer peripheral surface side of the first pump 60a, and merges with the brake fluid discharged from the outlet 65b of the first pump 60a.

That is, together with the second connection channel 145, the discharge chamber 54 that is formed on the outer peripheral surface side of the pump 60 other than the first pump 60a constitutes the distributary channel 142 that communicates with the discharge side of the pump 60. In other words, the discharge chamber 54 that is formed on the outer peripheral surface side of the pump 60 other than the first pump 60a constitutes a part of the distributary channel 142 that communicates with the discharge side of the pump 60. In addition, the discharge chamber 54 that is formed on the outer peripheral surface side of the first pump 60a is connected to a first connection channel 144 that constitutes a part of the merging channel 141 as will be described below. Accordingly, the discharge chamber 54 that is formed on the outer peripheral surface side of the first pump 60a constitutes the distributary channel 142 that communicates with the discharge side of the first pump 60a, that is, the first distributary channel 142a. Thus, a connected portion between the first connection channel 144 and the discharge chamber 54 that is formed on the outer peripheral surface side of the first pump 60a corresponds to the lowermost-stream side connected portion 143 depicted in FIG. 1 and FIG. 2.

Note that, in this embodiment, when the pump 60 is accommodated in the accommodation chamber 53, an annular channel 56 is formed between the outer peripheral surface of the pump 60 and the inner peripheral surface of the accommodation chamber 53, and the annular channel 56 is a space that communicates with the inlet 62c of the pump 60. That is, the annular channel 56 is a space that is formed annularly on the outer peripheral side of the pump 60 in the manner to communicate with the inlet 62c of the pump 60. The annular channel 56 is formed between the annular protrusion 61a of the cylinder 61 and the seal member 69. In other words, the annular channel 56 is formed on an outer peripheral side of the filter 70, which is provided to cover the opening of the inlet 62c.

The annular channel 56 communicates with the intermediate portion 14a of the secondary channel 14 in FIG. 1 and FIG. 2 by an internal channel that is not depicted and is formed in the base body 51. In other words, the annular channel 56 constitutes a part of the secondary channel 14. When the pump 60 is accommodated in the accommodation chamber 53, it is necessary to communicate between the inlet 62c of the pump 60 and the intermediate portion 14a. Due to provision of the annular channel 56, when the pump 60 is accommodated in the accommodation chamber 53, positioning of the pump 60 is unnecessary for the communication between the inlet 62c of the pump 60 and the intermediate portion 14a. Thus, due to the provision of the annular channel 56, the hydraulic pressure control unit 50 can easily be assembled. In addition, due to the provision of the annular channel 56, when the accommodation chamber 53 is processed in the base body 51, the secondary channel 14 is also partially processed. Thus, it is possible to cut the processing cost of the base body 51, that is, the manufacturing cost of the hydraulic pressure control unit 50. Furthermore, due to the provision of the annular channel 56, the space on the outer peripheral side of the pump 60 can effectively be used as the secondary channel 14. Thus, the base body 51, that is, the hydraulic pressure control unit 50 can be downsized.

As described above, the discharge chamber 54 that is formed on the outer peripheral surface side of the first pump 60a is connected to the first connection channel 144 that constitutes the part of the merging channel 141. This first connection channel 144 is configured by including an accommodation chamber 58 formed in the base body 51, a through-hole 144a, and a through-hole 144b. The accommodation chamber 58 is an accommodation chamber that accommodates the damper unit 80, and is a bottomed hole that is formed on the outer wall of the base body 51. The through-hole 144a is a through-hole that connects the accommodation chamber 58 and the discharge chamber 54, which is formed on the outer peripheral surface side of the first pump 60a. The through-hole 144b is a through-hole that connects the accommodation chamber 58 and the annular channel 55, which is formed on the outer peripheral surface side of the first pump 60a. That is, the brake fluid in the discharge chamber 54, which is formed on the outer peripheral surface side of the first pump 60a, flows into the accommodation chamber 58 through the through-hole 144a. Then, the pulsation of the brake fluid is dampened by the damper unit 80 that is accommodated in the accommodation chamber 58. The brake fluid whose pulsation has been dampened flows into the annular channel 55 through the through-hole 144b.

The annular channel 55 communicates with the intermediate portion 13b of the primary channel 13 in FIG. 1 and FIG. 2 by the internal channel that is not depicted and is formed in the base body 51. That is, the annular channel 55 constitutes a part of the merging channel 141. Due to provision of the annular channel 55, when the accommodation chamber 53 is processed in the base body 51, the merging channel 141 is also partially processed. Thus, it is possible to cut the processing cost of the base body 51, that is, the manufacturing cost of the hydraulic pressure control unit 50. In addition, due to the provision of the annular channel 55, the space on the outer peripheral side of the pump 60 can effectively be used as the merging channel 141. Thus, the base body 51, that is, the hydraulic pressure control unit 50 can be downsized.

When a portion around an opening of the accommodation chamber 58 is caulked, the damper unit 80, which is accommodated in the accommodation chamber 58, is fixed to the base body 51. This damper unit 80 includes a housing 81, a cover 82, a buffer 83, and a check valve 84.

The housing 81 has a bottomed cylindrical shape, one end of which is opened. The housing 81 accommodates the buffer 83 that is formed of a resilient body (for example, rubber or the like). The buffer 83 is formed with plural grooves 83a on an outer peripheral surface thereof, for example. The buffer 83 is also formed with a bottomed hole 83b that is opened in the same direction as an opening of the housing 81. In a state where the buffer 83 is accommodated in the housing 81, the outer peripheral surface of the buffer 83 abuts an inner peripheral surface of the housing 81. Each of the grooves 83a is in a state of being filled with fluid such as air.

The opening of the housing 81 is closed by the cover 82. This cover 82 is formed with an inflow port 82a and an outflow port 82b. Each of these inflow port 82a and outflow port 82b is a through-hole that communicates between the bottomed hole 83b of the buffer 83 and the outside of the damper unit 80. When the damper unit 80 is accommodated in the accommodation chamber 58, a space is formed between the cover 82 and a bottom portion of the accommodation chamber 58. The inflow port 82a is formed at a position that communicates between the space and the bottomed hole 83b of the buffer 83. Note that the above-described through-hole 144a communicates with the space between the cover 82 and the bottom portion of the accommodation chamber 58. Meanwhile, the outflow port 82b is formed at a position that communicates with the through-hole 144b when the damper unit 80 is accommodated in the accommodation chamber 58.

The outflow port 82b is provided with a check valve 84 that restricts a flow of the brake fluid from the outside of the damper unit 80 to the bottomed hole 83b of the buffer 83. When the hydraulic pressure of the brake fluid in the bottomed hole 83b of the buffer 83 becomes equal to or higher than a prescribed pressure, the check valve 84 is opened and thereby allows the brake fluid to flow from the outflow port 82b to the outside of the damper unit 80.

As depicted in FIG. 3, in the case where the pumps 60 and the damper units 80 are installed in the base body 51, the brake fluid flows as follows when the pumps 60 are driven.

When the drive shaft 57 is rotated by the drive source, which is not depicted, and the eccentric portion 57a formed on the drive shaft 57 moves toward the piston 62, the piston 62 is pressed toward the cylinder 61 side against the urging force of the spring 67. This increases the pressure in the pump chamber 63. Then, the ball valve 64a separates from the valve seat 64b, so as to open the discharge valve 64. In this way, the brake fluid in the pump chamber 63 flows through the through-hole 61c and the bottomed hole 65a of the cover 65 and is discharged from the outlet 65b to the discharge chamber 54.

When the drive shaft 57 is further rotated and the eccentric portion 57a formed on the drive shaft 57 starts being rotated in a direction to separate from the piston 62, the piston 62 moves in a direction to separate from the cylinder 61 by the urging force of the spring 67. This lowers the pressure in the pump chamber 63. Then, the ball valve 64a is seated on the valve seat 64b, and the discharge valve 64 is closed. In addition, the inlet valve, which is not depicted and closes the opening of the bottomed hole 62b of the piston 62 in the freely openable/closable manner, is opened. In this way, the brake fluid in the annular channel 56 flows into the pump chamber 63 through the filter 70, the inlet 62c, and the bottomed hole 62b.

When the drive shaft 57 is further rotated and the eccentric portion 57a, which is formed on the drive shaft 57, moves toward the piston 62 again, the piston 62 is pressed toward the cylinder 61 side as described above, and the brake fluid in the pump chamber 63 is discharged from the outlet 65b to the discharge chamber 54. Just as described, the piston 62 repeatedly reciprocates in the axial direction of the cylinder 61, and the inlet valve, which is not depicted, and the discharge valve 64 are selectively opened/closed. In this way, the brake fluid, the hydraulic pressure of which is increased, that is, which is pressurized, is discharged from the outlet 65b to the discharge chamber 54. Thus, the brake fluid that is pressurized by the pump 60 generates the pulsation.

The brake fluid, which is pressurized by the pump 60 other than the first pump 60a and is discharged to the discharge chamber 54 formed on the outer peripheral surface side of the pump 60, flows through the second connection channel 145 and flows into the discharge chamber 54 formed on the outer peripheral surface of the first pump 60a. Meanwhile, the brake fluid that is pressurized by the first pump 60a is discharged to the discharge chamber 54 formed on the outer peripheral surface side of the first pump 60a. That is, the entire brake fluid that is pressurized by the pumps 60 provided in each of the hydraulic circuits merges in the discharge chamber 54 formed on the outer peripheral surface side of the first pump 60a, then flows through the through-hole 144a, and flows into the accommodation chamber 58.

The brake fluid that has flowed into the accommodation chamber 58 flows through the inflow port 82a of the damper unit 80 and flows into the bottomed hole 83b of the buffer 83. In this way, a pressure in the bottomed hole 83b is increased, and the buffer 83 is deformed in a manner to increase capacity (a volume) of the bottomed hole 83b. This deformation becomes significant as the pressure in the bottomed hole 83b is increased, that is, as the hydraulic pressure of the brake fluid in the bottomed hole 83b is increased. Due to the deformation of the buffer 83, just as described, the pulsation of the brake fluid is dampened.

When the hydraulic pressure of the brake fluid in the bottomed hole 83b of the buffer 83 becomes equal to or higher than the prescribed pressure, the check valve 84 of the damper unit 80 is opened. In this way, the brake fluid whose pulsation has been dampened in the bottomed hole 83b of the buffer 83 flows out of the outflow port 82b to the outside of the damper unit 80, flows through the through-hole 144b and the annular channel 55, and flows into the intermediate portion 13b of the primary channel 13.

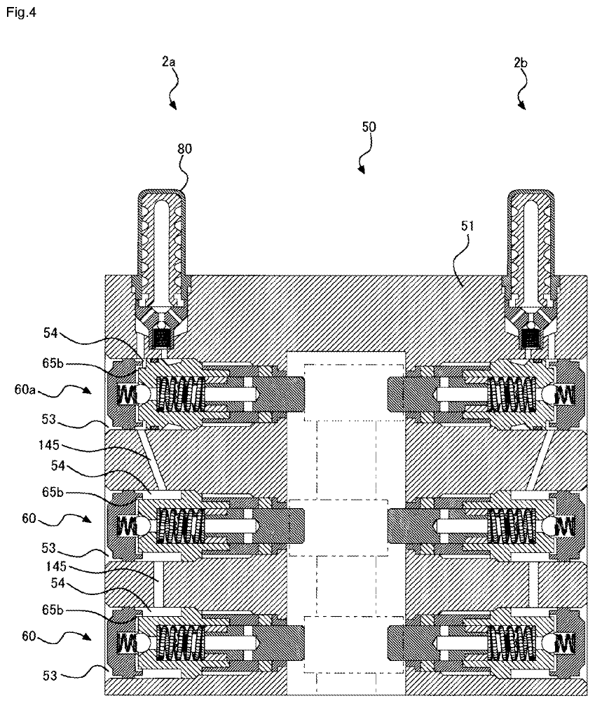

Note that the description has been made on the case where the two pumps 60, which are provided in each of the hydraulic circuits, are installed in the base body 51 with reference to FIG. 3. In the case where the three or more pumps 60 are provided in each of the hydraulic circuits, similar to FIG. 3, the third pump 60 onward may be installed in the base body 51. More specifically, the third pump 60 onward may be installed in the base body 51 in a similar manner to the pump 60 (the pump 60 depicted in a lower portion of FIG. 3) other than the first pump 60a. Then, the discharge chamber 54 that is formed on the outer peripheral surface side of each of the third pump 60 onward may communicate with the discharge chamber 54 that is formed on the outer peripheral surface side of the first pump 60a via the second connection channel 145. For example, each of the discharge chambers 54 that are formed on the outer peripheral surface sides of the pumps 60 other than the first pump 60a may directly be connected to the discharge chamber 54 that is formed on the outer peripheral surface side of the first pump 60a by the second connection channel 145. In the other words, each of the discharge chambers 54 that are formed on the outer peripheral surface sides of the pumps 60 other than the first pump 60a may be connected in parallel with the discharge chamber 54 that is formed on the outer peripheral surface side of the first pump 60a. Alternatively, for example, as depicted in FIG. 4, the discharge chambers 54 that are formed on the outer peripheral surface sides of the pumps 60 other than the first pump 60a may be connected in series by the second connection channels 145.

FIG. 4 is a partial cross-sectional view of another example of the state where the pumps and the damper units are installed in the base body of the hydraulic pressure control unit for the brake system according to the embodiment of the invention. Note that FIG. 4 depicts an example in which the three pumps 60 are provided in each of the hydraulic circuits 2a, 2b. That is, FIG. 4 depicts the example of providing the three pumps 60 in each of the hydraulic circuits. FIG. 4 also depicts the state where the drive shaft 57 that drives the piston 62 in each of the pumps 60 is removed. Thus, FIG. 4 depicts the drive shaft 57 and the eccentric portions 57a provided on the drive shaft 57 by the phantom lines (two-dot chain lines).

As depicted in FIG. 4, the discharge chamber 54 that is formed on the outer peripheral surface side of the pump 60 disposed in a lower portion of the base body 51 is connected to the discharge chamber 54 that is formed on the outer peripheral surface side of the pump 60 disposed in an intermediate portion of the base body 51 by the second connection channel 145. In addition, the discharge chamber 54 that is formed on the outer peripheral surface side of the pump 60 disposed in the intermediate portion of the base body 51 is connected to the discharge chamber 54 that is formed on the outer peripheral surface side of the first pump 60a disposed in an upper portion of the base body 51 by the second connection channel 145. Just as described, even when the discharge chambers 54, which are formed on the outer peripheral surface sides of the pumps 60, are connected, the brake fluid that is pressurized by all of the pumps 60 provided in each of the hydraulic circuits can flow into the damper unit 80. Thus, the single damper unit 80 can dampen the pulsation of the brake fluid that is generated by driving of the pumps 60.

In the case where each of the discharge chambers 54 communicates with the others as depicted in FIG. 4, in the discharge chamber 54 that is formed on the outer peripheral surface side of the pump 60 disposed in the intermediate portion, the brake fluid that has been pressurized in the pump 60 disposed in the lower portion merges with the brake fluid that has been pressurized in the pump 60 disposed in the intermediate portion. Then, this merged brake fluid flows from the discharge chamber 54 that is formed on the outer peripheral surface side of the pump 60 disposed in the intermediate portion, flows through the second connection channel 145 connected to the discharge chamber 54, and flows into the discharge chamber 54 that is formed on the outer peripheral surface side of the first pump 60a. That is, the discharge chambers 54 that are formed on the outer peripheral surface sides of the pumps 60 other than the first pump 60a are connected in series by the second connection channels 145. In this way, the second connection channel 145, through which the brake fluid discharged from the pump 60 on the downstream side in a flow direction of the brake fluid flows, can also be used as the second connection channel 145 through which the brake fluid discharged from the pump 60 on the upstream side flows. In this way, it is possible to reduce the number, processing time, and the like of the second connection channels 145, which are processed in the base body 51. Thus, when the discharge chambers 54 that are formed on the outer peripheral surface sides of the pumps 60 other than the first pump 60a are connected in series by the second connection channels 145, it is possible to cut the processing cost of the base body 51, that is, the manufacturing cost of the hydraulic pressure control unit 50. In addition, the base body 51, that is, the hydraulic pressure control unit 50 can be downsized.

### <Effects of Hydraulic Pressure Control Unit 50>

A description will be made on effects of the hydraulic pressure control unit 50 for the brake system 1 according to this embodiment.

In the hydraulic pressure control unit 50 according to this embodiment, the plural pumps 60, each of which increases the hydraulic pressure of the brake fluid, are provided in each of the hydraulic circuits. Accordingly, the hydraulic pressure control unit 50 according to this embodiment can reduce the discharge amount of the brake fluid from each of the pumps 60, and the discharge timing of the brake fluid from each of the pumps 60 can differ. Thus, the pulsation, which is generated during driving of the pumps 60, can be reduced. Furthermore, the hydraulic pressure control unit 50 according to this embodiment includes the damper units 80, each of which dampens the pulsation of the brake fluid discharged from the pumps 60. Thus, the hydraulic pressure control unit 50 according to this embodiment can further reduce the pulsation, which is generated during driving of the pumps 60.

Here, the hydraulic pressure control unit 50 according to this embodiment includes the discharge channels 140, each of which is the part of the secondary channel 14 and constitutes the channel between the discharge sides of the plural pumps 60 and the downstream end of the secondary channel 14. The discharge channel 140 includes: the merging channel 141 that has the downstream end of the secondary channel 14; and the distributary channels 142 that are respectively provided for the pumps 60 and respectively communicate with the discharge sides of the pumps 60. Each of the distributary channels 142 is connected to one of the other distributary channels 142 or the merging channel 141. Of the connected portions between the merging channel 141 and the distributary channels 142, the connected portion that is located closest to the downstream end of the secondary channel 14 is defined as the lowermost-stream side connected portion 143. At this time, the hydraulic pressure control unit 50 according to this embodiment is provided with the above-described damper unit 80 in the region on the downstream end side of the secondary channel 14 in the merging channel 141 with the lowermost-stream side connected portion 143 being the reference, and the damper unit 80 dampens the pulsation of the brake fluid that is discharged from the pumps 60. Thus, in the hydraulic pressure control unit 50 according to this embodiment, the single damper unit 80 can dampen the pulsation of the brake fluid that is discharged from the plural pumps 60. Therefore, the hydraulic pressure control unit 50 according to this embodiment can suppress the enlargement of the hydraulic pressure control unit 50.

Note that the hydraulic pressure control unit 50 preferably includes the base body 51 that is formed with the plural accommodation chambers 53 for respectively accommodating the pumps 60, and the discharge chamber 54 that communicates with the outlet 65b of the pump 60 and constitutes at least the part of the distributary channel 142 is preferably formed between the outer peripheral surface of each of the pumps 60 and the inner peripheral surface of each of the accommodation chambers 53 in state where the accommodation chamber 53 accommodates the pump 60. Due to the provision of the discharge chamber 54, when the pump 60 is accommodated in the accommodation chamber 53, positioning of the pump 60 is unnecessary for the connection between the outlet 65b of the pump 60 and the distributary channel 142. Thus, due to the provision of the discharge chamber 54, the hydraulic pressure control unit 50 can easily be assembled. In addition, due to the provision of the discharge chamber 54, when the accommodation chamber 53 is processed in the base body 51, the distributary channel 142 is also partially processed. Thus, it is possible to cut the processing cost of the base body 51, that is, the manufacturing cost of the hydraulic pressure control unit 50. Furthermore, due to the provision of the discharge chamber 54, the space on the outer peripheral side of the pump 60 can effectively be used as the distributary channel 142. Thus, the base body 51, that is, the hydraulic pressure control unit 50 can be downsized.

Furthermore, in the case where the pumps 60 are respectively accommodated in the accommodation chambers 53 of the base body 51, just as described, the hydraulic pressure control unit 50 is preferably configured that the space is formed between the outer peripheral surface of the first pump 60a and the inner peripheral surface of the accommodation chamber 53, that the space is partitioned into the first space (the annular channel 55) and the second space as the discharge chamber 54 by the partitioning portion 71, that the base body 51 has the first connection channel 144 constituting the part of the merging channel 141 and connecting the first space and the second space, that the damper unit 80 is provided in the first connection channel 144, and that the first space (the annular channel 55) is used as the part of the merging channel 141. Due to the provision of the first space (the annular channel 55), when the accommodation chamber 53 is processed in the base body 51, the merging channel 141 is also partially processed. Thus, it is possible to cut the processing cost of the base body 51, that is, the manufacturing cost of the hydraulic pressure control unit 50. In addition, due to the provision of the first space (the annular channel 55), the space on the outer peripheral side of the first pump 60a can effectively be used as the merging channel 141. Thus, the base body 51, that is, the hydraulic pressure control unit 50 can be downsized.

Moreover, each of the discharge chambers 54 that are formed on the outer peripheral surface sides of the pumps 60 other than the first pump 60a preferably communicates with the second space via the second connection channel 145 that constitutes the part of the distributary channel 142. At this time, the discharge chambers 54 that are formed on the outer peripheral surface sides of the pumps 60 other than the first pump 60a are preferably connected in series by the second connection channels 145. The discharge chambers 54 that are formed on the outer peripheral surface sides of the pumps 60 other than the first pump 60a are connected in series by the second connection channels 145. In this way, the second connection channel 145, through which the brake fluid discharged from the pump 60 on the downstream side in the flow direction of the brake fluid flows, can also be used as the second connection channel 145, through which the brake fluid discharged from the pump 60 on the upstream side flows. Thus, it is possible to reduce the number, processing time, and the like of the second connection channels 145, which are processed in the base body 51. Therefore, when the discharge chambers 54 that are formed on the outer peripheral surface sides of the pumps 60 other than the first pump 60a are connected in series by the second connection channels 145, it is possible to cut the processing cost of the base body 51, that is, the manufacturing cost of the hydraulic pressure control unit 50. In addition, the base body 51, that is, the hydraulic pressure control unit 50 can be downsized.

### REFERENCE SIGNS LIST

1: Brake system
2: Hydraulic circuit
2a: Hydraulic circuit
2b: Hydraulic circuit
11: Master cylinder
12: Wheel cylinder
13: Primary channel
13a, 13b: Intermediate portion
14: Secondary channel
14a: Intermediate portion
15: Supply channel
16: Brake pedal
17: Booster
18: Brake caliper
19: Brake pad
20: Rotor
31: Inlet valve
32: Outlet valve
33: Accumulator
35: First switching valve
36: Second switching valve
37: Damper unit
50: Hydraulic pressure control unit
51: Base body
52: Controller
53: Accommodation chamber
53a: Stepped portion
54: Discharge chamber
55: Annular channel
56: Annular channel
57: Drive shaft
57a: Eccentric portion
58: Accommodation chamber
59: Accommodation chamber
60: Pump
60a: First pump
61: Cylinder
61a: Protrusion
61b: Bottom portion
61c: Through-hole
62: Piston
62a: End
62b: Bottomed hole
62c: Inlet
63: Pump chamber
64: Discharge valve
64a: Ball valve
64b: Valve seat
64c: Spring
65: Cover
65a: Bottomed hole
65b: Outlet
66: Seal member
67: Spring
68: Guide member
69: Seal member
70: Filter
71: Partitioning portion
80: Damper unit
81: Housing
82: Cover
82a: Inflow port
82b: Outflow port
83: Buffer
83a: Groove
83b: Bottomed hole
84: Check valve
100: Vehicle
140: Discharge channel
141: Merging channel
142: Distributary channel
142a: First distributary channel
143: Lowermost-stream side connected portion
144: First connection channel
144a: Through-hole
144b: Through-hole
145: Second connection channel

1. A hydraulic pressure control unit for a vehicle brake system,
the brake system including
a hydraulic circuit having: a primary channel that communicates between a master cylinder and a wheel cylinder; a secondary channel to which brake fluid in the primary channel is released; and a supply channel through which the brake fluid is supplied to a first intermediate portion as an intermediate portion of the secondary channel,
a first downstream end as a downstream end of the secondary channel being connected to a second intermediate portion as an intermediate portion of the primary channel, and
a first upstream end as an upstream end of the supply channel communicating with the master cylinder,
the hydraulic pressure control unit comprising:
an inlet valve provided in a region on the wheel cylinder side in the primary channel with the second intermediate portion being a reference;
an outlet valve provided in a region between a second upstream end and the first intermediate portion in the secondary channel, the second upstream end being an upstream end of said secondary channel;
a first switching valve provided on the master cylinder side in the primary channel with the second intermediate portion being a reference;
a second switching valve provided in the supply channel;
plural pumps provided in a region between the first intermediate portion and the first downstream end in the secondary channel, wherein suction sides of the plurality of pumps communicating with said first intermediate portion, and discharge sides of the plurality of pumps communicating with said first downstream end; and
a discharge channel providing a part of the secondary channel and providing a channel between the discharge side of each of the plural pumps and the first downstream end, wherein the discharge channel includes:
a merging channel having the first downstream end; and
distributary channels respectively provided for the pumps and respectively communicating with the discharge sides of the pumps,
wherein each of the distributary channels is connected to one of the other distributary channels or the merging channel, and
when, of connected portions between the merging channel and the distributary channels, the connected portion that is located closest to the first downstream end is defined as a lowermost-stream side connected portion,
the hydraulic pressure control unit includes
a damper unit in a region on a first downstream end side in the merging channel with the lowermost-stream side connected portion being a reference, the damper unit dampening pulsation of the brake fluid that is discharged from the plural pumps.

2. The hydraulic pressure control unit according to claim 1 further comprising:
a base body formed with plural accommodation chambers that respectively accommodate the pumps, wherein
in a state where the pumps are respectively accommodated in the accommodation chambers,
a discharge chamber is formed between an outer peripheral surface of each of the pumps and an inner peripheral surface of each of the accommodation chambers, the discharge chamber communicating with an outlet of the pump and providing at least a part of the distributary channel.

3. The hydraulic pressure control unit according to claim 2, wherein
when the distributary channel that is connected to the merging channel in the lowermost-stream side connected portion is defined as a first distributary channel and
a one of the pumps having a discharge side that communicates with the first distributary channel among the pumps is defined as a first pump,
a space is formed between an outer peripheral surface of the first pump and the inner peripheral surface of the accommodation chamber,
said space is partitioned into a first space and a second space as the discharge chamber by a partitioning portion,
the base body has a first connection channel that provides a part of the merging channel and connects the first space and the second space,
the damper unit is provided in said first connection channel, and
the first space is used as a part of the merging channel.

4. The hydraulic pressure control unit according to claim 3, wherein
each of the discharge chambers that are formed on the outer peripheral surface sides of the pumps other than the first pump communicates with the second space via a second connection channel that provides a part of the distributary channel.

5. The hydraulic pressure control unit according to claim 4, wherein
the discharge chambers that are formed on the outer peripheral surface sides of the pumps other than the first pump are connected in series by the second connection channel.
